(19) United States
(12) Patent Application Publication
(10) Pub. No.: US 2021/0178847 A1
(43) Pub. Date: Jun. 17, 2021

(54) METHOD FOR OPERATING AN AIR SUSPENSION SYSTEM, AND AIR SUSPENSION SYSTEM

(71) Applicant: Continental Teves AG & Co. oHG, Frankfurt (DE)

(72) Inventor: Dierk Hein, Wedemark (DE)

(73) Assignee: Continental Teves AG & Co. oHG, Frankfurt (DE)

(21) Appl. No.: 17/121,327

(22) Filed: Dec. 14, 2020

(30) Foreign Application Priority Data
Dec. 17, 2019 (DE) 10 2019 219 880.5

(51) Int. Cl. B60G 17/015; B60G 11/27; B60G 17/019

(52) U.S. Cl. CPC B60G 17/0155; B60G 11/27; B60G 17/019; B60G 2202/152; B60G 2800/914; B60G 2400/51222; B60G 2500/2021; B60G 2500/30; B60G 2600/181; B60G 2400/252

(57) ABSTRACT

A method for operating an electronically controllable air suspension system of a vehicle comprises determining a first pressure value in a first air spring which is assigned to a first axle of the motor vehicle, and determining a second pressure value in a second air spring which is assigned to a second axle of the motor vehicle. A differential pressure value is calculated therefrom. A first nominal value for the air volume flow as a function of the differential pressure value is determined. At least one first air spring valve assigned to the first air spring is actuated so that the first nominal value for the air volume flow is set by the first air spring valve.

### CROSS-REFERENCE TO RELATED APPLICATIONS

This U.S. patent application claims the benefit of German patent application No. 10 2019 219 880.5, filed Dec. 17, 2019, which is hereby incorporated by reference.

### TECHNICAL FIELD

The invention relates to an air suspension system and a method for operating the air suspension system.

### BACKGROUND

Electronically controlled air suspension systems for ride height adjustment of a car are known. The main components of the air suspension system are adjustable air springs which provide springing for the vehicle superstructure, and an air supply device which provides compressed air. These two components are connected together via pneumatic lines. Also, various sensors are provided, such as height and pressure sensors, and a control unit which can function as a control and evaluation device. Various switching valves are provided in the pneumatic lines, which are controlled by means of the control unit to assume different switching states (open/closed). It is understood that the sensors and the switching valves are connected to the control unit via electrical lines.

The air suspension system allows active control of the height/level of the vehicle superstructure relative to a vehicle axle or the road surface. By switching specific valves, the air springs are filled or evacuated depending on requirement in order to adjust the vehicle ride height. Thus, after loading the vehicle, a height adjustment may be performed, or the vehicle may be lowered during travel in order to save fuel.

In a closed air supply system, the vehicle is lowered by discharging compressed air from the air springs directly or via a compressor into a pressure accumulator. With lowering per axle, firstly compressed air from the air springs of one axle is discharged or conveyed into the pressure accumulator, and then compressed air from the air springs of the other axle is discharged into the same pressure accumulator. Because of the pressure differences of air springs relative to the pressure accumulator, and the associated delivery power, the adjustment speed is low. In an open system, the compressed air from the air springs is discharged to the environment. Here, the pressure difference between the air springs and the environment determines the adjustment speed.

The adjustment per axle also takes place during lifting, i.e. raising the vehicle superstructure, in which, in the closed system, compressed air is transferred from the pressure accumulator into the air springs directly or via the compressor, or in which, in the open system, the compressed air is transferred from the pressure accumulator or from the environment to the air springs via the compressor.

In the prior art therefore, when raising and lowering the vehicle superstructure, the air springs are actuated axle by axle, which leads to a rocking effect which is undesirable and has a negative influence on comfort. Also, the successive nature of per axle adjustment extends the adjustment time within which a desired level setting is achieved.

Parallel adjustment of the vehicle superstructure could prevent this. However, a simultaneous and even adjustment of the axles can only be achieved with difficulty because of the wide range of use of the air springs. Because the air springs stand under a minimum to a maximum load, and the height is adjusted between a minimum and a maximum level, there are almost infinitely many pressure states for the air springs of the motor vehicle. Thus, for example, in the air springs of the rear axle, pressures in the range from 2 to 15 bar may be present, and the air springs of the front axle may be loaded with pressures between 5 to 15 bar. These pressures may be present over the various vehicle levels.

If all air spring valves are opened simultaneously in an adjustment process, the compressed air flows into the pressure chambers/volumes with the lower pressure or compressed air flows out of the air springs with the highest pressure at a higher speed. This means that the vehicle superstructure behaves uncontrollably.

Only under quite specific load conditions and level states can a pressure balance exist in the air springs, which would fulfil the desire for parallel raising/lowering of the vehicle superstructure. This is however rarely the case. Rather, load shifts lead to different pressures in the air springs since these are filled in order for the vehicle superstructure to be in a balanced or normal situation.

DE 198 47 106 A1 describes a pneumatic vehicle ride height control device in which the vehicle ride height is adjusted or modified as evenly as possible. With this device, all valves to the air springs of the front and rear axles are opened simultaneously. However, only if the pressures in the air springs are equal does this lead to parallel adjustment; since on raising, the compressed air flows firstly into the air springs with the lower pressure and thus raises these more quickly than the other air springs, and on lowering, the compressed air first flows out of the air springs with the higher pressure and thus lowers these more quickly than the other air springs In both cases, parallel adjustment is not possible.

DE 10 2011 121 756 A1 describes an air suspension system in which at least one air spring is connected to the main line of the air suspension system via two parallel connection lines which are each provided with a level control valve. The air mass stream flowing into or out of the air springs can be controlled by opening only one of the two level control valves or by opening both level control valves. An additional valve on the air spring allows the setting of a second nominal width. In this way, different flow speeds of the air mass stream for filling or emptying the air springs can be set. A parallel raising and lowering of the vehicle superstructure may take place however only under previously defined pressure states, since the available flow speeds are fixed by the nominal valve widths. Thus, it is not possible to provide an even and simultaneous adjustment process over the entire working range of the air suspension system, i.e. from unloaded to full load and from lowest to highest level.

Uneven and uncontrolled adjustment processes have the disadvantage that the motor vehicle may for example stand higher at the front than at the rear, which can lead to dazzling of oncoming traffic.

It is therefore desireable to provide an improved air suspension system and method which provide a simple structure that ensures an even and simultaneous adjustment of the vehicle superstructure.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method is provided for operating an electronically controllable air suspension system of a motor vehicle, wherein a ride height of the vehicle can be changed by operating the air suspension system, with the following steps determining a first pressure value in a first air spring which is assigned to a first axle of the motor vehicle, and determining a second pressure value in a second air spring which is assigned to a second axle of the motor vehicle. A differential pressure value is calculated from the first and second pressure values. A first nominal value for the air volume flow as a function of the differential pressure value is determined. At least one first air spring valve assigned to the first air spring is actuated so that the first nominal value for the air volume flow is set by the first air spring valve at the first air spring of the first axle.

A level of the motor vehicle may mean the height of the vehicle superstructure relative to the road surface. This height or level can be changed by operating the air springs of the air suspension system. For this, compressed air is conveyed into or discharged from the air springs. A change in air quantity in the air springs leads to a change in the position of the vehicle superstructure relative to the vehicle axles. The air suspension system may work in a closed air supply mode, in which compressed air can be displaced between the air springs and a pressure accumulator.

The air spring valves are the valves of the air suspension system which control the inflow and outflow of compressed air in the respective air springs. These are the valves which are either arranged in a compressed air line to the air springs, or in the actual air spring, and connect the volume of the air spring acting as a spring to the remainder of the system.

The air volume flow, also called the throughflow rate, indicates the volume or quantity of compressed air which flows through an established cross-section per time interval.

The adjustment speed for raising or lowering the motor vehicle at the axles is balanced. By setting a first nominal value for the air volume flow, the adjustment speed at the first axle is adapted to the maximum possible adjustment speed of the second axle. Thus, the balanced adjustment speed on both axles allows a more precisely targeted and overall faster adjustment of the vehicle superstructure.

Depending on requirements for raising or lowering the vehicle, pressure values of at least one air spring per vehicle axle are determined. Then a differential pressure value for the pressure values is determined which indicates the pressure difference between the axles. The differential pressure value is calculated for example by subtracting the second pressure value from the first pressure value or vice versa. The calculated pressure difference indicates which air spring or which axle must be actuated specifically, or how the air volume flow into or out of the air springs of this axle must be adjusted. Accordingly, from the determined pressure difference, the first nominal air volume flow is determined which determines the effective air volume flow into or out of the air spring. For this, the air spring valve assigned to the air spring is actuated or energized so as to set this first nominal air volume flow.

According to one embodiment, at least one second air spring valve assigned to the second air spring is actuated so that a second nominal value for the air volume flow is set by the second air spring valve at the second air spring of the second axle. The second nominal value for the air volume flow may be achieved by a fully opened second air spring valve.

Because the first air spring valve sets the first nominal value for the volume flow, and hence reduces the maximum possible air volume flow at the first air spring, and the second air spring valve allows a maximum possible air volume flow at the second air spring by being completely opened, the adjustment speeds of the two air springs are balanced. This balancing of the adjustment speeds or flow speeds into or from the air springs is based on the pressure difference previously determined.

It may be sufficient to determine only the pressure of one air spring per axle, and then actuate both air springs of this axle with the correspondingly determined first nominal air volume flow. Therefore, the air spring valves of the two air springs of the first axle are actuated so that they set the first nominal value for the air volume flow.

Optionally, the air spring valves of both air springs of the second axle are actuated so that they set the second nominal value for the air volume flow. In this way, it is sufficient to know merely the pressure value of one air spring per axle, and set the same nominal air volume flow on both air springs of the respective axle.

However, pressure values in all air springs of the motor vehicle may be determined, and from the pressure values of all air springs, specific nominal values for the air volume flow for all air spring valves are determined. These specific nominal values for the air volume flow per air spring are determined from the calculated differential pressure values between the individual air springs. Consequently, the air spring valves of the air springs of the first axle are actuated accordingly to set individual nominal values for the air volume flow. The air spring valves of the air springs of the second axle may furthermore be fully opened, or individual nominal values for the air volume flow may also be set. An even adjustment of the vehicle superstructure is thus possible for all different pressure conditions in the individual air springs.

According to a further embodiment, the first nominal value for the air volume flow is determined from a predefined table. Since the first nominal value for the air volume flow is derived from the differential pressure value of two air springs, it is useful to create a table of air volume flow to pressure which is filled with empirically determined air volume flow values that ensure the desired effect under specific pressure conditions. The first nominal value for the air volume flow can be read from this table as a function of the determined pressure difference.

A further embodiment provides that an electromagnetic switching valve is provided as the first air spring valve. The electromagnetic switching valve may be actuated with a pulse duration modulation. This pulse duration modulation preferably takes place with a frequency between 10 and 50 Hz. The pulse duration modulation sets the first nominal air volume flow at the first air spring. It is understood that all air spring valves of the air suspension system may be configured as electromagnetic switching valves. Accordingly, all air spring valves of the air suspension system are configured to set a nominal value for the air volume flow.

An alternative embodiment provides that an electromagnetic proportional valve is provided as the first air spring valve. The proportional valve allows very precise setting of the nominal value for the air volume flow since it can set the nominal width or opening cross-section very precisely between completely closed and completely opened. Here too, electromagnetic proportional valves may be used for all air spring valves of the suspension system so as to be able to set a nominal value for the air volume flow at each air spring valve.

According to a further embodiment, a height sensor detects the changing level of the motor vehicle. Thus, an even adjustment of the level of the motor vehicle can be monitored.

An air suspension system of a motor vehicle comprises a plurality of air springs, by which a ride height of the motor vehicle can be changed by the supply and extraction of compressed air, wherein at least two of the air springs are assigned to a first axle of the motor vehicle, and wherein two further air springs are assigned to a second axle of the motor vehicle, wherein an air spring valve is assigned to each air spring. A compressed air supply unit provides compressed air by aspiration of surrounding air or compression of system air. A pressure sensor for determining pressure values is provided. A first nominal value for the air volume flow is set at least at one of the air spring valves of the air springs of the first axle. The first nominal value for the air volume flow depends on a differential pressure value which results from a first pressure value in one of the air springs of the first axle and from a second pressure value in one of the air springs of the second axle. The system may be a closed air suspension system. The air suspension system may further comprise a pressure accumulator.

The air suspension system acc allows simultaneous and even adjustment of the vehicle superstructure because the air volume flow is adjusted at one air spring, and the air volume can e.g. flow completely to another air spring. In this way, in the case of pressure differences and known load conditions, the adjustment speed for changing the level of the motor vehicle on both axles can be balanced. Because of the reduction in air volume flow on one axle, in contrast to the former complete opening of the air spring valves according to the prior art, with the described air suspension system, parallel raising and lowering of the vehicle superstructure can take place. Thus also the general adjustment speed is increased since both axles are adjusted simultaneously, and not successively as in the prior art.

According to an embodiment, a second nominal value for the air volume flow is set at least at one of the air spring valves of the air springs of the second axle. Preferably, the air spring valve of one air spring of the second axle is completely opened. Thus, the maximum effectively possible air volume flow passes through this valve. Accordingly, the adjustment speeds on the axles of the motor vehicle are balanced.

The first nominal value for air volume flow may be set at the air spring valves of the air springs of the first axle. Optionally, the second nominal value for air volume flow is set at the air spring valves of the air springs of the second axle.

In a further embodiment, one of the air spring valves of the air springs of the first axle is an electromagnetic switching valve or an electromagnetic proportional valve. The desired air volume flow is set by a specific actuation of the electromagnetic valve, wherein these low-cost switching valves can still be used. The more costly proportional valves however allow a more precise setting of the desired air volume flow.

The air suspension system can be controlled electronically by a control unit. Therefore, in a further embodiment, the air suspension system comprises a control unit which receives height signals from a height sensor. The changing level of the motor vehicle can be monitored via the received height signals. The first and the second air spring valves can also be actuated electronically by the control unit.

The air suspension system may be used in a motor vehicle.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE FIGURES

The present disclosure will become more fully understood from the detailed description and the accompanying drawings, wherein:

FIG. 1 illustrates a pneumatic circuit diagram of an open function air suspension system;

FIG. 2 illustrates a pneumatic circuit diagram of a closed function air suspension system;

FIG. 3a illustrates an exemplary flow diagram for raising a motor vehicle;

FIG. 3b illustrates an exemplary flow diagram for lowering a motor vehicle; and

FIG. 4 illustrates a duty cycle of an electromagnetic valve.

### DETAILED DESCRIPTION

FIG. 1 shows a first pneumatic circuit diagram of an electronically controllable air suspension system 1 of a motor vehicle, which works in an open air supply mode. This comprises a compressor 3 which is driven by an electric motor 2. Several air springs 5 to 8 as pneumatic control units are each assigned to a respective vehicle wheel of the motor vehicle in order to adjust the height of the vehicle superstructure. Two air springs together are assigned to each axle of the motor vehicle. Thus the air springs 5 and 6 are assigned to a first axle A, and the air springs 7 and 8 are assigned to a second axle B of the motor vehicle. An air spring valve 21 to 24 is connected upstream of each air spring 5 to 8. Thus the air spring valves 21 and 22 belong to the first axle A, and the air spring valves 23 and 24 belong to the second axle B. Optionally, the open air suspension system may have a pressure accumulator for storing compressed air.

Also, the air suspension system 1 comprises a dryer 4 which is designed to dry the air drawn in from the environment by the compressor 3, and a choke check valve 13 connected downstream of the dryer 4. In order to provide compressed air for the air springs 5 to 8, the compressor 3 draws in air from the atmosphere via an inlet 9 and conveys this to the air springs 5 to 8 via a main line 12, a dryer 4 and a choke check valve 13. Compressed air can be discharged from the air suspension system 1 via an outlet 10 which can be closed by a switchable outlet valve 16.

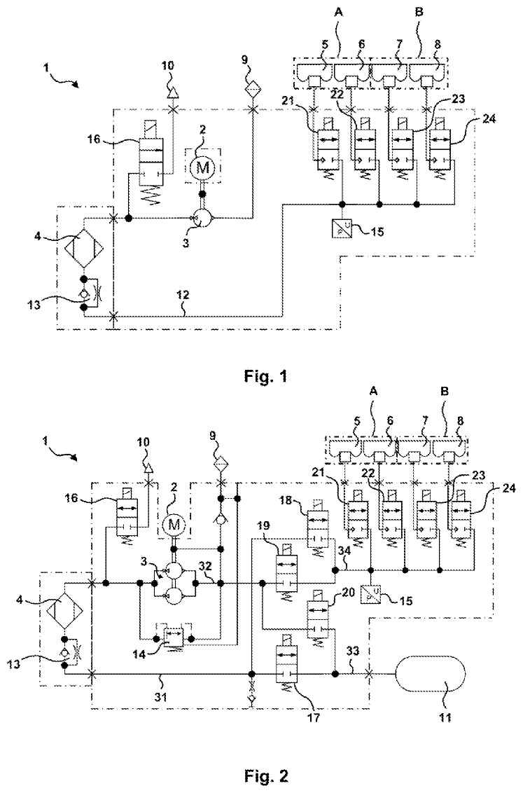

FIG. 2 shows a pneumatic circuit diagram of an electronically controllable air suspension system 1 of a motor vehicle which works in a closed air supply mode. This air suspension system 1 again comprises a compressor 3 which is driven by an electric motor 2, but the compressor 3 is designed as a double-piston compressor. As in the open function air suspension system 1, in the closed function air suspension system 1 again, several air springs 5 to 8 as pneumatic control units are each assigned to a respective vehicle wheel of the motor vehicle in order to adjust the height of the vehicle superstructure. Thus, the air springs 5 and 6 are assigned to a first axle A, and the air springs 7 and 8 are assigned to a second axle B of the motor vehicle. An air spring valve 21 to 24 is connected upstream of each air spring 5 to 8. Thus, the air spring valves 21 and 22 belong to the first axle A, and the air spring valves 23 and 24 belong to the second axle B.

Also, the air suspension system 1 comprises a dryer 4 which is designed to dry the air drawn in from the environment by the compressor 3, and a choke check valve 13 connected downstream of the dryer 4. In order to store the aspirated air as system air in the air suspension system 1, a pressure accumulator 11 is provided. Furthermore, a changeover valve device is provided which connects together the compressor 3, pressure accumulator 11 and air springs 5 to 8. This changeover valve device consists of four changeover valves 17 to 20, which are configured as electronically controllable 2/2-way directional control valves. Also, a pressure sensor 15 is provided to determine the pressure in the various components of the air suspension system.

In order to provide compressed system air, the compressor 3 draws in air from the atmosphere via an inlet 9. System air can be expelled from the air suspension system 1 via an outlet 10 which can be closed by a switchable discharge valve 16. A power-limiting valve 14 is provided bridging the compressor inlet and outlet.

On the outlet side of the compressor 3, a first compressed air line 31 leads to a first changeover valve 17 and to a second changeover valve 18. This first compressed air line 31 comprises a first line portion leading to the first changeover valve 17, and a second line portion leading to the second changeover valve 18.

On the inlet side of the compressor 3, a second compressed air line 32 leads to a third changeover valve 19 and to a fourth changeover valve 20, while a first line portion of the second compressed air line 32 leads to the third changeover valve 19 and a second line portion of the second compressed air line 32 leads to the fourth changeover valve 20.

From the pressure accumulator 11, a third compressed air line 33 with a first line portion leads to the first changeover valve 17, and with a second line portion leads to the fourth changeover valve 20.

The adjustment process for filling and raising the vehicle superstructure by means of the air suspension system 1 is outlined briefly below. The closed air supply mode is distinguished in that the system air can be shifted to and fro between the pressure accumulator 11 and the air springs 5 to 8. An adjustment process is either initiated by the system or takes place by user selection, in order to lower the vehicle for example for entry and exit.

Firstly, the compressor 3 draws air in from the atmosphere via the inlet 9 and fills the pressure accumulator 11 with the compressed air, also known as system air. This takes place via the first and third compressed air lines 31, 33. For this, the electric motor 2 of the compressor 3 is actuated by the control unit and moves at least the first changeover valve 17 into an open switch position.

In order now to transfer the compressed air into the air springs 5 to 8 so that they can raise the vehicle superstructure and hence adjust the ride height, the system air is transferred from the pressure accumulator 11 to the air springs 5 to 8 by means of the compressor 3. The third and second compressed air lines 33, 32 are used for this, wherein the fourth changeover valve 20 is opened so that the compressor 3 is supplied with system air from the pressure accumulator 11. This system air is then compressed further and supplied via the first compressed air line 31 to the open second changeover valve 18, so that the compressed system air flows via the fourth compressed air line 34 into the air springs 5 to 8, depending on the switch position of the air spring valves 21 to 24. In this adjustment process, the first and third changeover valves 17, 19 remain closed.

It is also possible to transfer system air from the pressure accumulator 11 into the air springs 5 to 8 without operating the compressor 3. For this, a corresponding pressure difference in compressed air between the pressure accumulator 11 and the air springs 5 to 8 is required, which can be determined by the pressure sensor 15. If now the pressure accumulator 11 has a sufficiently higher pressure level than the pressure level in the air springs 5 to 8, compressed air from the pressure accumulator 11 can overflow into the air springs 5 to 8 via the third compressed air line 33 when the first and second changeover valves 17, 18 are open, and via the fourth compressed air line 34.

In order to lower the vehicle, it is possible to transfer compressed air from the air springs 5 to 8, via the compressor 3, to the pressure accumulator 11. The compressed air is conducted via the fourth compressed air line 34 when the third changeover valve 19 is opened, and via the second compressed air line 32, to the inlet of the compressor 3 where it is compressed, and from the outlet of the compressor 3 via the first compressed air line 31 when the first changeover valve is opened, and via the third compressed air line 33, into the pressure accumulator 11.

Although not shown in FIGS. 1 and 2, it is self-evident that a control unit is provided belonging to the respective electronically controlled air suspension system 1; the electronic components of the suspension system 1 are connected to said control unit and can be actuated thereby. The electronic components include for example the electric motor 3, all switching valve 16 to 24, the power-limiting valve 14, and the pressure sensor 15.

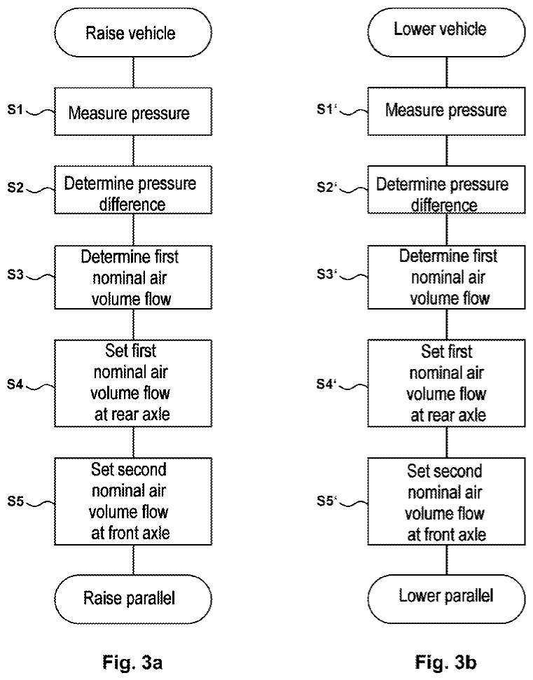

FIG. 3a shows a flow diagram for an exemplary adjustment process for raising a motor vehicle. The pressures in the air springs of an axle of the motor vehicle are usually approximately equal. In the case of an uneven load distribution however, the pressure in the air springs of an axle may also deviate from each other. In the following example, an approximate pressure balance of the air springs of an axle is assumed.

Firstly, in step S1, a pressure measurement is performed in each air spring of each axle. This may take place via a pressure sensor which is arranged in the compressed air line leading to the air springs. Thus, a pressure value of the compressed air in the volume of an air spring acting as a spring is determined or measured. Alternatively, pressure may be measured in both air springs per axle of the motor vehicle.

Then in step S2, the pressure values from the pressure measurement are compared and hence a pressure difference between the air springs of the two axles is determined. The calculated differential pressure value thus results e.g. from the compressed air in an air spring of the rear axle and from the compressed air in an air spring of the front axle. In this example, a pressure of 8 bar on the front axle and a pressure of 4 bar on the rear axle are assumed. This gives a pressure difference of 4 bar between the axles. From this comparison, the axle with the lower pressure is determined. According to the exemplary figures given, the rear axle is the axle with the lower pressure.

When the air spring valves of the front axle are completely opened, according to the example, a possible air volume flow into the air springs of the front axle would amount to 10 L/min. When the air spring valves of the rear axle are fully opened, the possible air volume flow into the air springs of the rear axle would be 20 L/min, because here the counter pressure is lower. Thus, twice as much compressed air would flow in the same time into the air springs of the rear axle as into the air springs of the front axle, whereby the rear axle would be adjusted with a higher adjustment speed that the front axle. The air volume flow which can flow into an air spring depends not only on the known counter-pressure but also on the pre-pressure which is provided by the known compressor delivery curve or the directly connected accumulator pressure.

In order however to ensure even adjustment of both axles, the air volume flow into the air springs of the rear axle must be adjusted. This is achieved in that an air volume flow of 0.5 times the possible flow is set at the air spring valves of the rear axle. Accordingly, in step S3, a first nominal value for the air volume flow is determined as a function of the determined differential pressure value, giving a flow of 10 L/min into the air springs of the rear axle.

Accordingly, in step S4, the air spring valves of the rear axle are actuated so as to set the first nominal value for the air volume flow of 10 L/min.

While the air spring valves of the rear axle are actuated according to the first nominal value for the air volume flow, in step S5, the air spring valves of the front axle are actuated so as to set a second nominal value for the air volume flow to the air springs of the front axle. This may be achieved in that the air spring valves of the front axle are completely opened. Since this axle has a higher pressure, when the air spring valves of the front axle are fully opened, the maximum possible air volume will flow into the air springs of the front axle. Alternatively, the second nominal value for the air volume flow may also be set specifically in order to achieve a better fine-tuning during raising. Since, during the raising process, the air volume flow into the air springs with the lower pressure must be reduced so that these are not filled too quickly, in this example the air spring valves of the rear axle are actuated to set the first nominal value for the air volume flow, which is approximately equal to the air volume flow at the opened air spring valves of the front axle.

The steps described in this exemplary adjustment process lead to a parallel raising of the vehicle relative to the road surface. The height of the vehicle superstructure is adjusted evenly by means of the air springs on both axles of the motor vehicle simultaneously. In other words, the adjustment speed is the same on the air springs of both axles. This avoids a rocking effect of the vehicle superstructure during raising.

The flow diagram in FIG. 3b depicts an exemplary adjustment process for lowering the motor vehicle. For this the adjustment process too, it is assumed that there is an approximate pressure equilibrium in the air springs of an axle.

Firstly, in step S1′, a pressure measurement is performed in each air spring of each axle. A pressure value of the compressed air in the volume of an air spring acting as a spring is determined or measured. Alternatively, here again, pressure may be measured in both air springs per axle of the motor vehicle.

Then in step S2′, the pressure values from the pressure measurement are compared and hence a pressure difference between the air springs of the two axles is determined. The calculated differential pressure value thus results e.g. from the compressed air in an air spring of the rear axle and from the compressed air in an air spring of the front axle. In this example, a pressure of 4 bar on the front axle and a pressure of 8 bar on the rear axle are assumed. This gives a pressure difference of 4 bar. From this comparison, the axle with the higher pressure is determined. According to the exemplary figures given, the rear axle is the axle with the higher pressure.

When the air spring valves of the front axle are completely opened, according to the example, a possible air volume flow out of the air springs of the front axle would amount to 10 L/min. When the air spring valves of the rear axle are fully opened, the possible air volume flow out of the air springs of the rear axle would be 20 L/min, because here the pressure is higher. Thus, twice as much compressed air would flow in the same time out of the air springs of the rear axle as out of the air springs of the front axle. The air volume flow which can flow out of an air spring depends on the known counter-pressure and on the pre-pressure which is taken from the known compressor delivery curve, since the compressor is normally used to compress the air flowing out of the air springs and deliver it to the pressure accumulator.

In order however to ensure even adjustment of both axles, the air volume flow out of the air springs of the rear axle must be adjusted. This is achieved in that an air volume flow of 0.5 times the possible flow is set at the air spring valves of the rear axle. Accordingly, in step S3′, a first nominal value for the air volume flow is determined as a function of the determined differential pressure value, giving a flow of 10 L/min out of the air springs of the rear axle.

In step S4′, the air spring valves of the rear axle are actuated so as to set the first nominal value for the air volume flow of 10 L/min.

While the air spring valves of the rear axle are actuated according to the first nominal value of the air volume flow, in step S5′, the air spring valves of the front axle are actuated so as to set a second nominal value for the air volume flow out of the air springs of the front axle. This may be achieved in that the air spring valves of the front axle are completely opened. Since this axle has a lower pressure, when the air spring valves are fully opened, the maximum possible air volume will flow out of the air springs of the front axle. Alternatively, the second nominal value for the air volume flow may also be set specifically in order to achieve a better fine-tuning during lowering. Since, during the lowering process, the air volume flow out of the air springs with the higher pressure must be reduced so that these are not evacuated too quickly, in this example the air spring valves of the rear axle are actuated to set the first nominal value for the air volume flow, which is approximately equal to the air volume flow at the opened air spring valves of the front axle.

The steps described in this exemplary adjustment process lead to a parallel lowering of the vehicle relative to the road surface. The height of the vehicle superstructure is adjusted evenly by means of the air springs on both axles of the motor vehicle simultaneously. In other words, the adjustment speed is the same on the air springs of both axles. This avoids a rocking effect of the vehicle superstructure during lowering.

To set the first nominal value for the air volume flow through an air spring valve, electromagnetic switching valves or electromagnetic proportional valves are used.

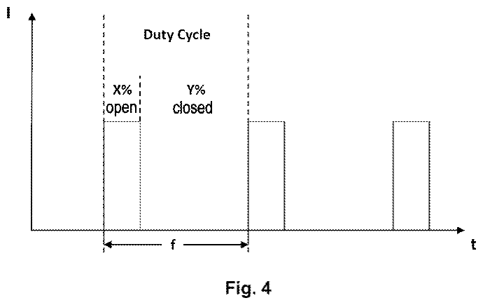

FIG. 4 shows a duty cycle according to which an electromagnetic switching valve is actuated for the exemplary setting of the first nominal value of the air volume flow. The switching valve is actuated with a current intensity I over time t such that the ratio between the opening time to the closing time can be varied between 0%=permanently closed to 100%=permanently open. The duty cycle is repeated with a sufficiently rapid frequency f to set the air volume flow with sufficient precision. The frequency f may be for example between 10 and 50 Hz. This method of energizing the switching valve sets the air volume flow which flows through the valve per time interval.

While the best modes for carrying out the invention have been described in detail the true scope of the disclosure should not be so limited, since those familiar with the art to which this invention relates will recognize various alternative designs and embodiments for practicing the invention within the scope of the appended claims.

1. A method for operating an electronically controllable air suspension system of a motor vehicle, wherein a ride height of the vehicle can be changed by operating the air suspension system comprising:
determining a first pressure value in a first air spring which is assigned to a first axle of the motor vehicle, and determining a second pressure value in a second air spring which is assigned to a second axle of the motor vehicle;
calculating a differential pressure value from the first and second pressure values;
determining a first nominal value for the air volume flow as a function of the differential pressure value; and
actuating at least one first air spring valve assigned to the first air spring so that the first nominal value for the air volume flow is set by the first air spring valve at the first air spring of the first axle.

2. The method as claimed in claim 1, further comprising actuating at least one second air spring valve assigned to the second air spring so that a second nominal value for the air volume flow is set by the second air spring valve at the second air spring of the second axle.

3. The method as claimed in claim 1, wherein the first nominal value for the air volume flow is determined from a predefined table.

4. The method as claimed in claim 1, wherein an electromagnetic switching valve is provided as the first air spring valve.

5. The method as claimed in claim 4, wherein the electromagnetic switching valve is actuated with a pulse duration modulation.

6. The method as claimed in claim 5, wherein the pulse duration modulation is with a frequency between 10 and 50 Hz.

7. The method as claimed in claim 1, wherein an electromagnetic proportional valve is provided as the first air spring valve.

8. The method as claimed in claim 1, wherein a height sensor detects the changing ride height of the motor vehicle.

9. An air suspension system of a motor vehicle, comprising:
a plurality of air springs capable of changing a ride height of the motor vehicle by the supply and extraction of compressed air, wherein at least two of the air springs are assigned to a first axle of the motor vehicle, and wherein two further air springs are assigned to a second axle of the motor vehicle;
an air spring valve is assigned to each air spring,
a compressed air supply unit which provides compressed air by one of aspiration of surrounding air and compression of system air; and
a pressure sensor for determining pressure values, wherein a first nominal value for the air volume flow is set at least at one of the air spring valves of the air springs of the first axle, wherein the first nominal value for the air volume flow depends on a differential pressure value which results from a first pressure value in one of the air springs of the first axle and from a second pressure value in one of the air springs of the second axle.

10. The air suspension system as claimed in claim 9, wherein a second value for nominal air volume flow is set at least at one of the air spring valves of the air springs of the second axle.

11. The air suspension system as claimed in claim 9, wherein one of the air spring valves of the air springs of the first axle is one of an electromagnetic switching valve and an electromagnetic proportional valve.

12. The air suspension system as claimed in claim 9, wherein the air suspension system further comprises a control unit which receives height signals from a height sensor.
